(19) United States
(12) Patent Application Publication
(10) Pub. No.: US 2023/0040397 A1
(43) Pub. Date: Feb. 9, 2023

(54) Optical Thermography System Using a Pumped Two-dye Fluorescence Technique

(71) Applicant: Drexel University, Philadelphia, PA (US)

(72) Inventors: Matthew McCarthy, Media, PA (US); Deborah Kapilow, Berkeley Heights, NJ (US)

(73) Assignee: Drexel University, Philadelphia, PA (US)

(21) Appl. No.: 17/880,751

(22) Filed: Aug. 4, 2022

Related U.S. Application Data
(60) Provisional application No. 63/229,094, filed on Aug. 4, 2021.

(51) Int. Cl. G01J 5/48; G01J 5/061; G01J 5/08; G01J 5/04

(52) U.S. Cl. CPC G01J 5/48; G01J 5/061; G01J 5/0887; G01J 5/046

(57) ABSTRACT

A backside thermography technique was developed based on the temperature sensitivity of laser-induced fluorescence in flowing two-dye solutions. The approach utilizes visible light and optically transparent packaging materials to obtain spatially resolved transient thermal measurements. This technique is compatible with optically transparent water-cooled packaging, which will allow for the characterization of processes where heat is added as well as removed. A setup was designed, constructed, and used to study the performance of seven two-dye Rhodamine B (RhB)-Rhodamine 110 (Rh110) fluorescent solutions. The effect of dye concentration ratio on sensitivity, maximum frame rate, and excitation area was characterized. The system was used to demonstrate in-situ temperature measurements showing the importance of two-dye light compensation, as well as backside thermography using a simple droplet contact method to investigate temporal response. Droplet contact experiments were conducted on actively heated and cooled surfaces to study local temperature and heat flux behavior during phase change.

### CROSS-REFERENCE TO RELATED APPLICATION

The present application claims the benefit of U.S. Provisional Patent Application Ser. No. 63/229,094, filed on Aug. 4, 2021, which is incorporated herein by reference in its entirety.

### STATEMENT OF GOVERNMENT INTEREST

This invention was made with government support under Contract No. 1454497 awarded by the National Science Foundation. The Government has certain rights in this invention.

### BACKGROUND OF THE INVENTION

### Field of the Invention

The invention relates to optical thermography using a pumped two-dye fluorescence technique.

### Description of the Related Art

Thermography, or the use of thermal images to produce spatially resolved temperature data, has proven to be useful in a wide variety of applications, such as building diagnostics, firefighting, medicine, and electronics cooling and maintenance. Thermography is advantageous compared to contact-based temperature measurements, such as thermocouples and thermistors, because is it less invasive and can result in high-speed two-dimensional thermal images over large areas and temperature ranges. While high performance thermography techniques are being actively developed, including micro-Raman spectroscopy and surface plasmon resonance, these approaches are potentially limited in their implementation due to high costs and specific equipment needed. There are, however, several established techniques used for thermography, such as thermochromic liquid crystals, infrared thermography, and laser-induced fluorescence.

Although widely used for lab-scale backside thermography, infrared thermography (IRT) has some drawbacks despite its popularity. Infrared cameras can be expensive, especially those required to achieve high frame rates. IRT demands the use of infrared transparent materials and fluids, which prevents the use of many materials that are inexpensive and easy to machine, such as plastics. These specifications can result in IRT being incompatible for actively cooled applications. For these reasons, IRT can be considerably more costly and difficult to implement than a visible light technique.

It would be beneficial to use a visible light technique over an infrared technique for thermography.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is an optical thermography system comprising a base member having a temperature regulating fluid channel formed therein The temperature regulating fluid channel has a temperature regulating fluid inlet on a first side of the temperature regulating fluid channel and a temperature regulating fluid outlet on a second side of the temperature regulating fluid channel, distal from the temperature regulating fluid inlet. A fluorescent solution channel is formed in the base member. The fluorescent solution channel has a fluorescent solution fluid inlet on a first side of the fluorescent solution channel and a fluorescent solution fluid outlet on a second side of the fluorescent solution channel, distal from the fluorescent solution fluid inlet. A test sample surface is disposed above the fluorescent solution channel.

In an alternative embodiment, the present invention provides an optical thermography system comprising a base member having a lower fluid channel formed therein. The lower fluid channel has a lower fluid inlet on a first side of the temperature regulating fluid channel and a lower fluid outlet on a second side of the temperature regulating fluid channel, distal from the lower fluid inlet. An upper channel is formed therein above the lower channel. The upper channel has an upper fluid inlet on a first side of the fluorescent solution channel and an upper fluid outlet on a second side of the fluorescent solution channel, distal from the upper fluid inlet. A test sample surface is disposed above the upper channel.

In still another alternative embodiment, the present invention provides an optical thermography system comprising a lower base member and a lower fluid channel formed above the lower base member. The lower fluid channel has a lower fluid inlet on a first side of the temperature regulating fluid channel and a lower fluid outlet on a second side of the temperature regulating fluid channel, distal from the lower fluid inlet. An upper base member is located above the lower channel and an upper channel is formed above the upper base member. The upper channel has an upper fluid inlet on a first side of the fluorescent solution channel and an upper fluid outlet on a second side of the fluorescent solution channel, distal from the upper fluid inlet. A test sample surface is disposed above the upper channel.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a schematic view of an optical thermography system according to an exemplary embodiment of the present invention;

FIG. 2 is a top plan view of the system of FIG. 1;

FIG. 3 is a bottom plan view of the system of FIG. 1;

FIG. 4 is an absorption graph showing wavelength vs. normalized intensity for two fluorophores used with the system of FIG. 1;

FIG. 5 is an emission graph showing wavelength vs. normalized intensity for two fluorophores used with the system of FIG. 1;

FIG. 6 is a top plan view of a channel design used for determining light compensation using two-dye fluorescence;

FIG. 7 is a schematic view of a setup using the system of FIG. 1;

FIG. 8 is a perspective view of the setup of FIG. 7;

FIG. 9 is an enlarged view of a portion of FIG. 8;

FIG. 10 is a schematic view of the thickness of each layer of the inventive system beneath a test droplet, to scale; and

FIG. 11 is a schematic of the structure of the acrylic numerical scheme.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. As used herein, the term “about” means±10% of the given value.

The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Ph.D. Dissertation by Deborah Kapilow, Ph.D., dated Jul. 27, 2022 and entitled “Development of an Optical Thermography System Using a Pumped Two-dye Technique”, attached herein as an appendix to this Specification, is fully incorporated herein by reference.

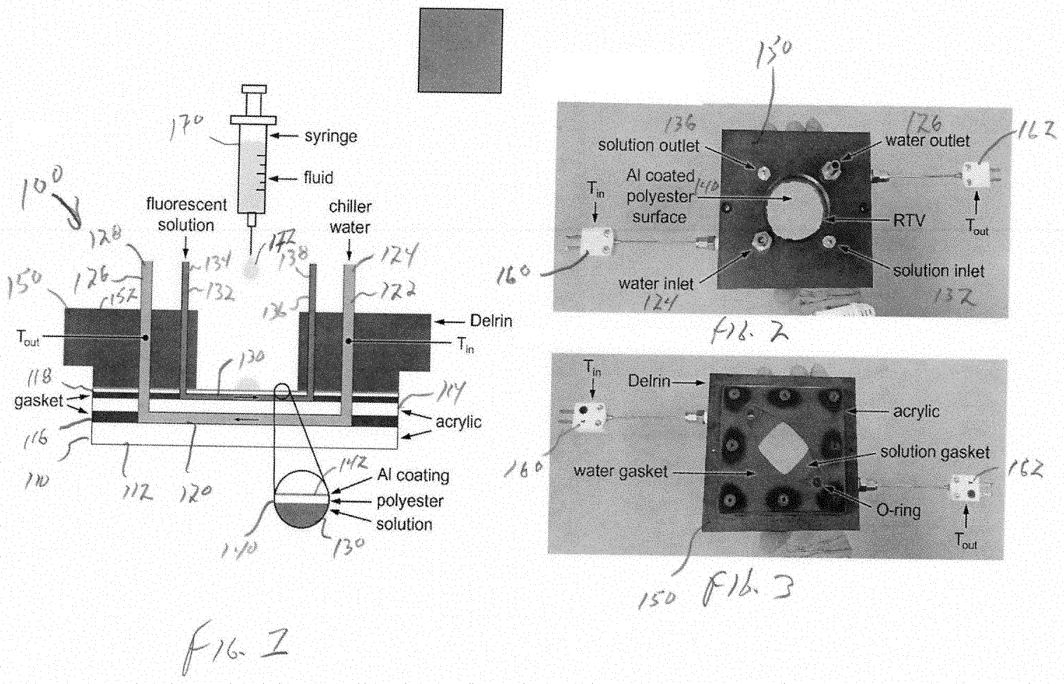

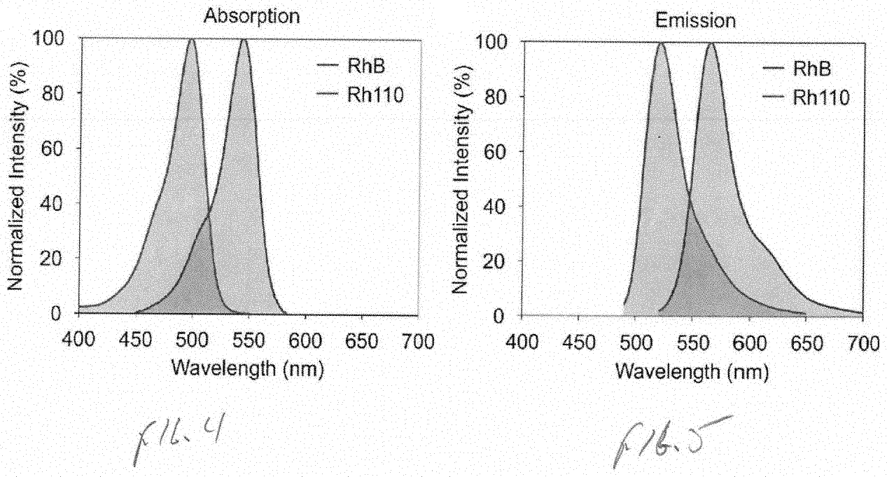

A custom-built experimental system was designed and constructed to characterize a two-dye fluorescent solution for in situ and surface thermography measurements. FIG. 1 shows a schematic representation of the inventive system and FIGS. 2 and 3 show top and bottom views, respectively, of the inventive system. The system is used to measure heat transfer and heat flux of different fluids under different thermal conditions.

Many heat transfer applications benefit from the study of other local heat transfer characteristics in addition to temperature data. One example is the study of phase change heat transfer. Phase change heat transfer is complex, and much is still unknown about the underlying mechanisms and elements which guide it. Some researchers have used IRT to study local heat flux in conjunction with local temperature distribution to gain a better understanding of the phenomena occurring beneath a boiling bubble.

The inventive system was designed and constructed to characterize a two-dye fluorescent solution for in situ and surface thermography measurements. Calibration experiments were performed on seven solutions with concentration ratios ranging from ¼ to four to determine sensitivity. The highest sensitivity was found for concentration ratios near unity and calibration experiments were found to be highly repeatable. A lower concentration ratio results in higher maximum frame rates and larger excitation areas for the concentration ratio values tested. The effect of temperature and concentration ratio on photobleaching behavior was characterized. Due to the combination of high dye concentrations and low excitation light intensity used, the effects of photobleaching in this work were found to be much less significant than those found in the prior art. Additionally, the flowable nature of this technique provides a method to reduce, and possibly eliminate, the effects of photobleaching. Experiments were conducted with spatial and temporal resolutions of 25 to 30 μm and 24 Hz, respectively, to show the potential use of this thermography technique for in situ and backside surface measurements. The experimental uncertainty of the temperature measurements was determined to be ±2.1° C. and good agreement was found between the experimental and predicted results. The inventive experimental setup was constructed that required the fluorescence output signal to be viewed through flowing coolant water to obtain local heat flux measurements in addition to local temperature. Droplet contact backside thermography experiments were performed using several fluids, including water, phase change material, methanol, and acetone. The effects of active cooling and heating as well as phase change on local temperature and heat flux behavior can also be studied using the inventive setup.

The advantage of a two-dye technique to account for error due to light fluctuations and non-uniform illumination was shown. This technique uses economical visible-light cameras and optics and is compatible with cheap optically transparent materials and fluids, including, but not limited to, plastics and water. While visible-light optics and cameras have the potential for high spatial resolutions, the temporal resolution of future systems will inevitably be limited by the thermal mass of the dye and the layers containing the dye. As a result, techniques such as IRT will always be able to provide faster time responses. The flexibility of a visible-light dye-injected thermography system, however, may allow these shortcomings to be minimized by using thinner dye layers that can be pumped into three dimensional spaces.

Referring to FIGS. 1-3, an optical thermography system 100 according to an exemplary embodiment of the invention is shown. System 100 includes a base member 110 having a temperature regulating fluid channel 120 and a fluorescent solution fluid channel 130 formed therein. A test sample surface 140 is disposed above the fluorescent solution channel 130. A thermal insulator 150 is located on the base member 110 and circumscribes the test sample surface 140.

Base member 110 can be constructed from an optically transparent or translucent polymer, such as acrylic, to allow incident light to pass therethrough. Base member 110 can be constructed from a lower base member 112, with temperature regulating fluid channel 120 being a lower fluid channel formed above the lower base member 112. In an exemplary embodiment, lower base member 112 can be constructed from a block of acrylic having a thickness of about 3.18 mm, although those skilled in the art will recognize that lower base member 112 can have other thicknesses. An upper base member 114, also constructed from acrylic, is located above the lower channel 120, with fluorescent solution fluid channel 130 formed above the upper base member 114.

As shown in FIG. 1, a first sealing member 116, such as a gasket material, can be used between lower base member 112 and upper base member 114 to provide additional thermal insulation for temperature regulating fluid channel 120. In an exemplary embodiment, first sealing member 116 can be about 1.59 mm thick, resulting in temperature regulating fluid channel 120 also being 1.59 thick. Also, in an exemplary embodiment, upper base member 114 can also be about 1.59 mm thick. Those skilled in the art, however, will recognize that first sealing member 116 and upper base member 114 can be other thicknesses.

A second sealing member 118, such as a gasket material, can be used between upper base member 114 and test sample surface 140 to provide additional thermal insulation for fluorescent solution fluid channel 130. In an exemplary embodiment, second sealing member 118 can be about 0.40 mm thick, resulting in fluorescent solution fluid channel 120 also being 0.40 mm thick. Those skilled in the art, however, will recognize that second sealing member 118 can be other thicknesses.

Temperature regulating fluid channel 120 is above the lower base member 112 and is configured to flow a temperature regulating fluid therethrough. The temperature regulating fluid can be a cooling fluid, such as chilled water, to cool base member 110 in order to determine condensation effects on test fluids. Alternatively, the temperature regulating fluid can be a heating fluid, such as hot water or even steam, to heat base member 110 to determine heating and evaporative effects on test fluids.

Temperature regulating fluid channel 120 has a temperature regulating fluid inlet 122 on a first side 124 of the temperature regulating fluid channel 120 and a temperature regulating fluid outlet 126 on a second side 128 of the temperature regulating fluid channel 120, distal from the temperature regulating fluid inlet 122. In an exemplary embodiment, temperature regulating fluid inlet 122 and temperature regulating fluid outlet 126 extend through the thermal insulator 150 and, as shown in FIG. 2, temperature regulating fluid inlet 122 is diametrically opposite temperature regulating fluid outlet 126.

Temperature regulating fluid channel 120 included temperature-controlled flowing water from a chiller that could heat or cool the surface of channel 120. The fluorescent emission signal was consequently viewed through flowing water. This concept allows for this technique to be used in actively heated and cooled applications, which is very difficult to accomplish with infrared thermography.

Referring to FIGS. 2 and 3, a first temperature measurement device 160 in the form of a first thermocouple is located at the temperature regulating fluid inlet 122 and a second temperature measurement device 162 in the form of a second thermocouple is located at the temperature regulating fluid outlet 126.

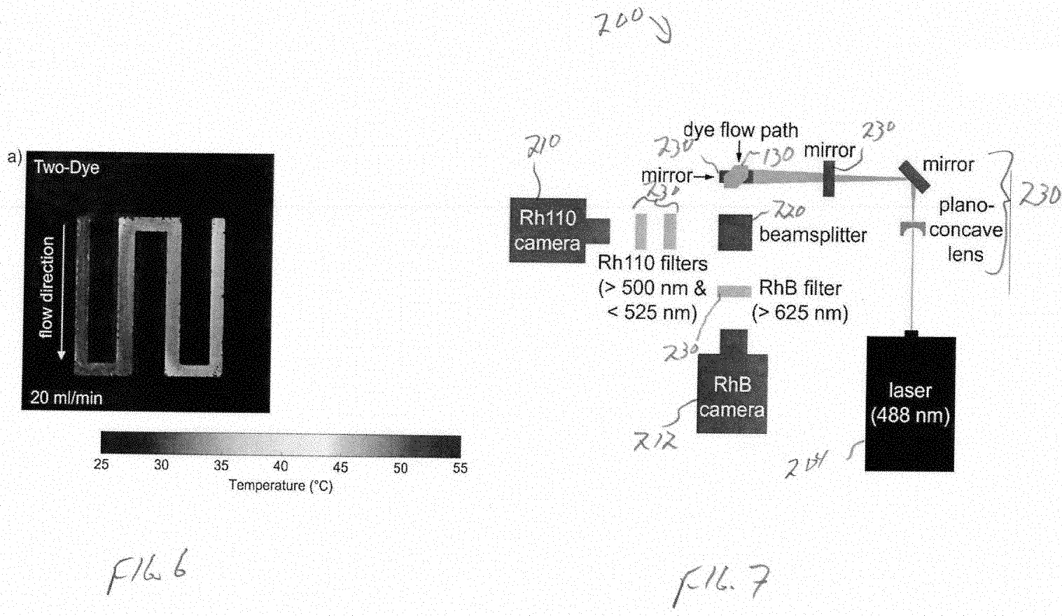

Fluorescent solution channel 130 is formed in base member 110, above temperature regulating fluid channel 120 and upper base member 114 and is configured to flow a thermographic fluid therethrough. The thermographic fluid can be a two-dye fluorophore fluid. The use of two fluorophores results in reduced error due to light fluctuations, non-uniform illumination, and non-uniform dye concentration when compared to a single-dye sensor. Two fluorophores can be used in conjunction with one another for thermal measurements by normalizing the data from the temperature dependent dye by that of the dye which is insensitive to temperature. In an exemplary embodiment, the two-dye system described above used Rhodamine B and Rhodamine 110 (manufactured by Acros Organics) as the temperature dependent and temperature independent dye, respectively. It is necessary for the two fluorophores to have an overlap in absorption spectra so a single excitation light source can be used. Additionally, the emission spectra must be different enough to be separated using optical filters so that each dye can be viewed individually. The absorption and emission spectra for RhB and Rh110 are shown in FIGS. 4 and 5. FIG. 4 shows an area of overlap for the absorption curves of the two dyes while FIG. 5 shows that regions exist where each dye can be separated from one another for individual viewing.

Fluorescent solution fluid channel 130 has a fluorescent solution fluid inlet 132 on a first side 134 of the fluorescent solution fluid channel 130 and a fluorescent solution fluid outlet 136 on a second side 138 of the fluorescent solution fluid channel 130, distal from the fluorescent solution fluid inlet 132. FIG. 6 shows an exemplary channel pattern for fluorescent solution fluid channel 130, although those skilled in the art will recognize that other channel configurations can be used.

In an exemplary embodiment, fluorescent solution fluid inlet 132 and fluorescent solution fluid outlet 136 extend through the thermal insulator 150 and, as shown in FIG. 2, fluorescent solution fluid inlet 132 is diametrically opposite fluorescent solution fluid outlet 136, on either side of temperature regulating fluid inlet 122 and temperature regulating fluid outlet 126.

Test sample surface 140 is located above fluorescent solution fluid channel 130 and is bounded by thermal insulator 150. Test sample surface 140 comprises an optically transparent polymer, such as polyester, with an aluminum coating 142 on the optically transparent polymer. In an exemplary embodiment, test sample surface 140 can be 0.13 mm thick, although those skilled in the art will recognize that test sample surface 140 can be other thicknesses.

Thermal insulator 150 comprises a polymer, and can be between about 0.5 mm and about 1.0 mm thick, although those skilled in the art will recognize that thermal insulator 150 can be other thicknesses. Thermal insulator 150 is located on the base member 110 and has a top surface 152 through which temperature regulating fluid inlet 122, temperature regulating fluid outlet 126, fluorescent solution fluid inlet, and fluorescent solution fluid outlet 136 extend.

In an exemplary embodiment, a 50.8 mm wide hole is formed through thermal insulator 150 to provide an opening for depositing a test sample droplet onto test sample surface 140.

A syringe 170 is used to dispense a drop 172 of fluid onto test sample surface 140 for testing.

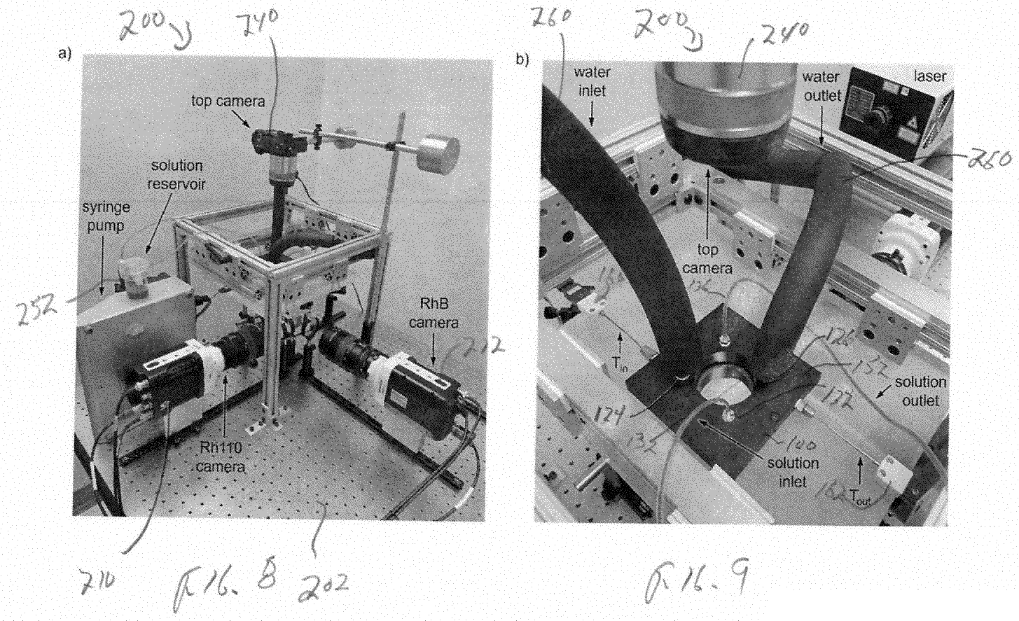

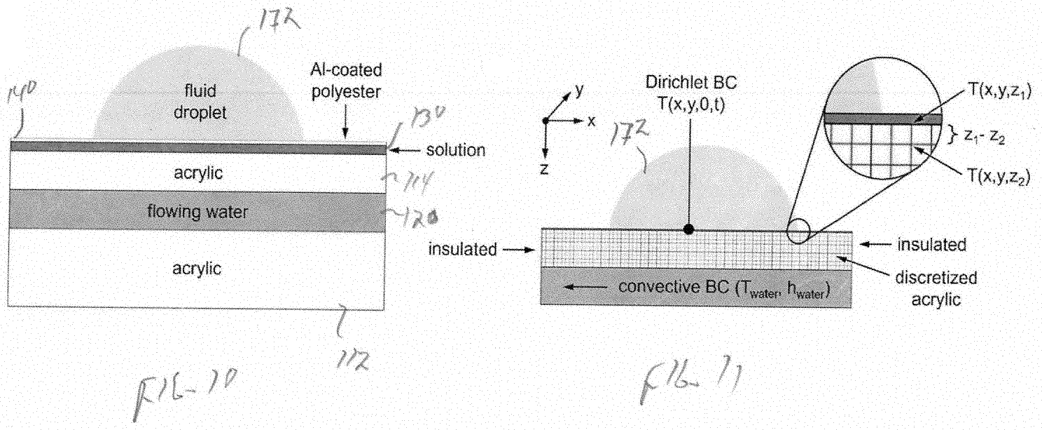

An experimental setup 200 using system 100 is shown assembled on the optical table 202 in FIGS. 7-9. Many of the optical components used with system 100 can be seen in FIG. 7, including a laser 204, RhB and Rh110 cameras 210, 212, a beam splitter 220, and several filters and mirrors 230. A mirrorless camera 240 (Sony a6300) was added to the setup 200 to record video of the top of the test sample surface 140 during testing. Syringe pump 170 was used to introduce new solution to the dye flow path as needed. A glass beaker 252 served as the solution reservoir to collect used solution after the solution passed through fluorescent solution fluid channel 130. FIG. 8 shows a zoomed-in photograph of the top side of the experimental setup 200. The coolant water passes through tubing 260 covered with black insulation to ensure minimal heat loss. The fluorescent solution can be seen in the solution inlet 132 and outlet 136 tubing. The thermocouples 160, 162 are connected to a data acquisition system 270 to record the water inlet and outlet temperature over time. The top camera 240 is held directly above the center of the exposed test sample surface 140 and is placed several inches away from the surface 140 to provide space to conduct experiments freely without any interference from the camera 240.

The above-described experimental setup 200 yields local temperature in the solution layer as a function of space and time. In order to obtain local heat flux measurements, a numerical scheme was generated in MATLAB to model the temperature distribution inside the piece of acrylic separating the solution and water layers. FIG. 10 displays the thickness of each layer beneath the test sample surface 140 to scale. This illustration is helpful to understand the assumptions associated with the numerical scheme. The structure of the numerical scheme is shown in FIG. 11. The acrylic upper base member 114 was discretized into a mesh where each pixel in the temperature images was assigned a node in x and y. The upper base member 114 was broken into 20 nodes in the z direction to allow for accuracy while also minimizing computational cost. The 3D transient heat conduction equation:

∂/∂x(kac∂T/∂x)+∂/∂y(kac∂T/∂y)+∂/∂z(kac∂T/∂z)+q=ρac cp,ac∂T/∂t Eqn. 1

was used to find the temperature of each node in the upper base member 114 at each time step, where ka, ρa, and cp,a represent the thermal conductivity, density, and specific heat capacity of acrylic, respectively. Since no internal heat was generated within the acrylic upper base member 114, q was set to zero.

It was assumed that the solution and polyester surface layers are infinitely thin for the numerical scheme, and thus, the temperature output from the solution layer is equal to the surface temperature profile. This assumption is not wholly accurate. The key to improving the validity of this assumption is to decrease the thickness of these layers, which should be a focus for future work and is likely possible with microfabrication. The upper boundary (z=0) is established at a Dirichlet boundary condition since the temperature of this infinitely thin layer is known at every pixel location and time step.

The lower boundary of the acrylic (z=c) was treated as a convective boundary condition using

−kax∂T∂z|_{z=c}=h_{water}[T(x,y,c,t)−T_{water}] Eqn. 2

where the heat transfer coefficient of the water, h_{water}, was estimated using

h_{water}=Nu k_{water}/Dₕ Eqn. 3

The hydraulic diameter, Dh, was calculated using the average width and height of the temperature regulating water channel 120 and was found to be 2.94 mm. Since the width of the channel 120 was more than 10 times the height, a Nusselt number of 7.54 was used based on an assumption of fully developed laminar flow between two parallel plates. Using a thermal conductivity for water, or kw, of 0.6 W/m*K, the heat transfer coefficient was calculated to be 1537 W/m²*K. The temperature of the coolant water, T_{water}, was evaluated as the average of the thermocouple readings for Tᵢₙ, and Tₒᵤₜ during the experiment. T_{x,y,c,t} represents the temperature at the bottom of the acrylic. To start the numerical scheme, one initial temperature is assigned to the bottom of the acrylic (T_{x,y,c,0}=constant). This temperature is calculated with a simple thermal circuit using the convection condition in the water layer and the average temperature of the dye layer at t=0 s. For all subsequent time steps, the temperature at the bottom of the acrylic is calculated using the numerical scheme. Thus, each pixel will have a different temperature and the convective boundary condition must be evaluated at each node.

The sides of the acrylic were treated as insulating using

∂T/∂y|ₓ₌₀=∂T/∂y|ₓ₌ₐ=∂T/∂y|_{y=0}=∂T/∂y|_{y=b}=0 Eqn. 4

where a and b are the maximum values of x and y, respectively. This assumption is valid because the heat transfer is occurring under the droplet location towards the center of the surface. The side walls of the acrylic are far enough away from any heat transfer activity that it is appropriate to consider them insulating.

The described boundary conditions were used together to calculate the temperature at every node inside the discretized acrylic at each time step. Once that it accomplished, the local heat flux was calculated by taking the gradient of the temperature profile at the upper boundary using

q″(x,y,t)=−k_{ac}∂T/∂z|_{z=0} Eqn. 5

a. The temperature gradient approximated using

∂T/∂z≈[T(x,y,z₁)−T(x,y,z₂)]/[z₁−z₂] Eqn. 6

where z₁ and z₂ represent the top two nodes of the discretized acrylic, as illustrated in FIG. 10.

It will be further understood that various changes in the details, materials, and arrangements of the parts which have been described and illustrated in order to explain the nature of this invention may be made by those skilled in the art without departing from the scope of the invention as expressed in the following claims.

We claim:

1. An optical thermography system comprising:
a base member having:
a temperature regulating fluid channel formed therein, the temperature regulating fluid channel having a temperature regulating fluid inlet on a first side of the temperature regulating fluid channel and a temperature regulating fluid outlet on a second side of the temperature regulating fluid channel, distal from the temperature regulating fluid inlet; and
a fluorescent solution channel formed therein, the fluorescent solution channel having a fluorescent solution fluid inlet on a first side of the fluorescent solution channel and a fluorescent solution fluid outlet on a second side of the fluorescent solution channel, distal from the fluorescent solution fluid inlet; and
a test sample surface disposed above the fluorescent solution channel.

2. The optical thermography system according to claim 1, further comprising a thermal insulator on the base member, circumscribing the test sample surface.

3. The optical thermography system according to claim 2, wherein the temperature regulating fluid inlet, the temperature regulating fluid outlet, the fluorescent solution fluid inlet, and the florescent solution fluid outlet all extend through the thermal insulator.

4. The optical thermography system according to claim 3, wherein the temperature regulating fluid inlet is diametrically opposite the temperature regulating fluid outlet.

5. The optical thermography system according to claim 3, wherein the fluorescent solution fluid inlet is diametrically opposite the florescent solution fluid outlet.

6. The optical thermography system according to claim 2, wherein the thermal insulator comprises a polymer.

7. The optical thermography system according to claim 1, wherein the fluorescent solution channel extends above the temperature regulating fluid channel.

8. The optical thermography system according to claim 1, wherein the test sample surface comprises an optically transparent polymer.

9. The optical thermography system according to claim 8, further comprising an aluminum coating on the optically transparent polymer.

10. The optical thermography system according to claim 1, wherein the base member is constructed from an optically transparent or an optically translucent material.

11. The optical thermography system according to claim 1, wherein the fluorescent solution channel has a thickness of about 0.40 mm.

12. The optical thermography system according to claim 1, further comprising a first temperature measurement device at the temperature regulating fluid inlet and a second temperature measurement device at the temperature regulating fluid outlet.

13. An optical thermography system comprising:
a base member having:
a lower fluid channel formed therein, the lower fluid channel having a lower fluid inlet on a first side of the temperature regulating fluid channel and a lower fluid outlet on a second side of the temperature regulating fluid channel, distal from the lower fluid inlet;
an upper channel formed therein above the lower channel, the upper channel having an upper fluid inlet on a first side of the fluorescent solution channel and an upper fluid outlet on a second side of the fluorescent solution channel, distal from the upper fluid inlet; and
a test sample surface disposed above the upper channel.

14. The optical thermography system according to claim 13, further comprising a thermal insulator on the base member, the thermal insulator having a top surface.

15. The optical thermography system according to claim 14, wherein the lower fluid inlet, the lower fluid outlet, the upper fluid inlet, and the upper fluid outlet all extend from the top surface of the thermal insulator.

16. The optical thermography system according to claim 14, wherein the lower fluid inlet is diametrically opposite the lower fluid outlet.

17. The optical thermography system according to claim 14, wherein the upper fluid inlet is diametrically opposite the upper fluid outlet.

18. The optical thermography system according to claim 13, wherein the upper channel is configured to flow a thermographic fluid therethrough.

19. The optical thermography system according to claim 13, wherein the lower channel is configured to flow a temperature regulating fluid therethrough.

20. An optical thermography system comprising:
a lower base member:
a lower fluid channel formed above the lower base member, the lower fluid channel having a lower fluid inlet on a first side of the temperature regulating fluid channel and a lower fluid outlet on a second side of the temperature regulating fluid channel, distal from the lower fluid inlet; and
an upper base member located above the lower channel;
an upper channel formed above the upper base member, the upper channel having an upper fluid inlet on a first side of the fluorescent solution channel and an upper fluid outlet on a second side of the fluorescent solution channel, distal from the upper fluid inlet; and
a test sample surface disposed above the upper channel.
